(19) United States
(12) Patent Application Publication
(10) Pub. No.: US 2007/0151786 A1
(43) Pub. Date: Jul. 5, 2007

(54) Method to increase kinetic energy of a body

(76) Inventor: Thomas A. Gardner, Littleton, CO (US)

Correspondence Address: THOMAS A. GARDNER, 5608 SOUTH FORESTHILL STREET, LITTLETON, CO, 80120, US

(21) Appl. No.: 11/323,170

(22) Filed: Jan. 3, 2006

(51) Int. Cl. B60K 25/10

(52) U.S. Cl. 180/165

(57) ABSTRACT

The present invention provides a method by a unique combination of the elements of gravity, moving vehicles, inclined planes of various geometries, epicycloid rolling resistance abatement, momentum conversion, regenerative braking, apparatus for converting inertial of moving vehicles into power, vehicular thoroughfares for power generation, and road traffic actuated generators whereby a result of the acquisition of a vehicle or vehicle wheel kinetic energy is realize. Subsequently, the increase of a vehicle kinetic energy shall be converted to electrical power or other type of energy for good and productive uses by the aforesaid methods, means, and apparatus.

### CROSS-REFERENCE TO RELATED APPLICATIONS

None.

### STATEMENT REGARDING FEDERALLY SPONSORED RESEARCH OR DEVELOPMENT

This application does not involve any rights to inventions made under federally sponsored research and development.

### BACKGROUND OF THE INVENTION

This invention relates generally to energy and more particularly to a method, hitherto unknown, to increase the kinetic energy of a body of mass.

Hydrocarbon energy sources are limited, expensive and pose environmental hazards. The latest alternative energy trend is to split the water molecule into hydrogen and oxygen whereupon the hydrogen will subsequently be used as fuel. Clean energy depends on the source of the energy. If hydrogen is clean energy, the means for obtaining the hydrogen must be taken into consideration. In other words, if the hydrogen is obtained by means of fossil fuels the negative environmental impacts remain. Nuclear power plants introduce long term waste material hazards as well as potential site security issues. Hydroelectric energy by means of dam building is constrained due to environmental concerns. Solar, geothermal, and wind energy, although promising, have yet to meet economic breakeven. Solar energy is intermittent due to daylight and cloudless skies. Wind energy is also intermittent because the wind occasionally does not blow. The force of gravity is omnipresent and ubiquitous about the earth's surface and available regardless whether the sun is shining or the wind is blowing. Therefore, additional alternative energy sources are meritorious of consideration.

Some devices which convert kinetic energy into other types of energy are:

| | | |
|---|---|---|
| U.S. Pat. No. | 1,916,873 | Wiggins |
| U.S. Pat. No. | 4,409,489 | Hayes |
| U.S. Pat. No. | 4,418,542 | Ferrel |

Some rumble strip devices are disclosed by:

| | | |
|---|---|---|
| U.S. Pat. No. | 4,790,684 | Adams |
| U.S. Pat. No. | 5,327,850 | Sly, et al |

A method to mitigate rolling resistance is:

| | | |
|---|---|---|
| U.S. Pat. No. | 4,878,525 | Gardner |

The art of Wiggins, Hayes, and Ferrell entitled APPARATUS FOR CONVERTING INERTIA OF MOVING VEHICLES INTO POWER, VEHICULAR THOROUGHFARES FOR POWER GENERATION, AND ROAD TRAFFIC ACTUA TED GENERATOR, respectfully, which describe and disclose means for converting vehicle movement into a type of power. Adherence to the conservation of energy law of physics is not discussed within their art.

The art of Adams and Sly, et al generally address warning systems known as rumble strips by inducing vibrations and noise whereof the vehicle operator is warned of travel way departure. However, the method presented herein shall use the rumble strips as means to preclude slippage of various member elements of the present invention, particularly to the springs elements coacting with the roadway surface while sequaciously operating as disclosed by the following art of Gardner.

Gardner's art provides means of rolling resistance abatement for vehicle wheels by means of sequaciously storing and releasing energy by way of compression springs attached in a recessed manner to the periphery hub of a vehicle wheel. Gardner's art also discloses the operation with a multiplicity of vehicle wheels cooperating and communicating with synchronisation optimization.

Momentum converters are means which provide conversion of momentum into a form of stored energy. Momentum converters are sometimes referred to as regenerative braking where vehicle wheels cooperate and communicate via gears, chains, rotation transmission means, or other means to an electrical generator or other energy storage devise situated on board a vehicle whereof the vehicle momentum is via transmission from the vehicle wheel rotation to the generator in a propositioned and predetermined manner, said rotational energy is converted to electrical energy or other form of energy and subsequently stored in batteries or by other energy storage means, and ultimately said energy is available for reuse in vehicle propulsion. Regenerative braking has been successfully commercially implemented. The said stored energy could also be used for other uses other than vehicle propulsion.

Vacuum chambers have many uses. Generally, vacuum chambers are comprised of a rigid chamber with interior matter, such as air, removed. An example of a vacuum chamber is a light bulb. The use of vacuum chambers herein shall be in anticipation of minimizing moving vehicle drag forces due to air resistance.

The concept of heat transfer is well known by anyone skilled in the art of mechanical engineering. Heat is transferred in the light bulbs via the filament to the bulb surface whereat the heat is dissipated. The means providing of heat transfer herein shall be in anticipation of minimizing deleterious heat accumulation within the peripheral elements of the epicycloid rolling resistance abatement.

The concept of retraction of elements and the means appertaining thereto is well known by anyone skilled in the art of mechanical engineering. For example, the aircraft landing gear is retracted to improve the aerodynamic properties while in flight. The means providing of element retraction herein shall be in anticipation of minimizing resistance but inclusion of retraction providing means of the peripheral elements of the epicycloid rolling resistance abatement.

In an ideal world, the concept of conservation of energy is well known and generally accepted throughout the scientific community. Simply stated, energy cannot be created nor destroyed but only transformed into different forms. The forms of energy of an object are usually categorized into kinetic energy, —that is to say energy due to motion, potential energy—that is to say energy related to position as situated in a gravitational field, and internal energy-energy represented by molecular energy which may exist in sensible, latent, chemical, and nuclear forces. Energy may change form but the overall total energy in a closed volume of space remains the same.

An example of energy transformation would be the release of a basketball situated under the influence of a gravitational field. The basketball would incur an increase of kinetic energy while undergoing a decrease of potential energy. Upon contact with the floor, the kinetic energy would be transformed into internal energy due to the temporary increase in air pressure within the ball. Subsequently, the air pressure would be restored to the original pressure upon rendering the ball in an upward motion—in other words the bounce of the ball—and the ball would acquire kinetic energy in the opposite, upward direction until the ball returns to the original position whereat the kinetic energy would be transformed to potential energy whereat the ball would come to an instantaneous stop. Again in an ideal world, the energy transformation process from potential, to kinetic energy, to internal energy then back to kinetic energy, and subsequently back to potential energy would continue indefinitely.

Another scenario, is the condition when the basketball is at rest on the floor whereupon the basketball does not transform energy, but does provide weight as a force. This force is transferred to the earth's lithosphere resulting in a slight geological pressure. This pressure is not present when the basketball is in motion or at the top of the bounce arc.

The theory of general relativity requires physical laws apply regardless of the frame of reference within which the experiments are performed. The perspective of interest herein is within general relativity and is known as the principle of equivalence. The principle of equivalence contends there is no discernible difference, from the perspective of physical laws, between the effects of a gravitational frame of reference, when compared to an accelerating frame of reference. Einstein's argument of the principle of equivalence, also known as THE EQUALITY OF GRA VITA TIONAL AND INERTIAL MASS goes as follows.

“We imagine a large portion of empty space, so far removed from stars and other appreciable masses, that we have before us approximately the conditions required by the fundamental law of Galilei. It is then possible to choose a Galileian reference-body for this part of space (world), relative to which points at rest remain at rest and points in motion continue permanently in uniform rectilinear motion. As reference-body let us imagine a spacious chest resembling a room with an observer inside who is equipped with apparatus. Gravitation naturally does not exist for this observer. He must fasten himself with strings to the floor, otherwise the slightest impact against the floor will cause him to rise slowly towards the ceiling of the room.

To the middle of the lid of the chest is fixed externally a hook with rope attached, and now a “being” (what kind of a being is immaterial to us) begins pulling at this with a constant force. The chest together with the observer then begin to move “upwards ” with a uniformly accelerated motion. In course of time their velocity will reach unheard-of values-provided that we are viewing all this from another reference-body which is not being pulled with a rope.

But how does the main in the chest regard the process? The acceleration of the chest will be transmitted to him by the reaction of the floor of the chest. He must therefore take up this pressure by means of his legs if he does not wish to be laid out full length on the floor. He is then standing in the chest in exactly the same way as anyone stands in a room of a house on our earth. If he releases a body which he previously had in his hand, the acceleration of the chest will no longer be transmitted to this body, and for this reason the body will approach the floor of the chest with an accelerated relative motion. The observer will further convince himself that the acceleration of the body towards the floor of the chest is always of the same magnitude, whatever kind of body he may happen to use for the experiment.

Relying on his knowledge of the gravitational field (as it was discussed in the preceding section), the man in the chest will thus come to the conclusion that he and the chest are in a gravitational field which is constant with regard to time. Of course he will be puzzled for a moment as to why the chest does not fall in this gravitation field. Just then, however, he discovers the hook in the middle of the lid of the chest and the rope which is attached to it, and he consequently comes to the conclusion that the chest is suspended at rest in the gravitation field.”

The present invention should be viewed from another reference-body which is not being pulled by rope. We further would like the man in the chest that resembles a room in which an experiment by the method disclosed of the present invention, that is to say, with an inclined plane and the embodiment of the present invention and method which resides within the room. Placement of an inclined plane within the chest is not difficult to envision.

The principle of equivalence is referenced herein in order to disclose the operation of the present invention without the encumbrances of presuppositions and preconceptions of gravitational effects on rigid and none rigid bodies. The transformation from kinetic energy to potential energy and subsequently back to potential energy without regard to the earth's increase of internal energy.

A level plane used in regard to the present invention is simply a special case of an inclined plane. The term inclined plane used herein shall include curved surfaces as well as other surface geometries, materials and shall not be restricted to a plane.

Metamorphic rocks have been transformed by metamorphism which is a change in the constitution of rock which is caused by pressure, heat, and water resulting in more compact and more highly crystalline condition of the rock. The pressure as cause could be attributed in part to a mountain which resides on the surface of the earth. If this mountain were to be placed within a very large vehicle fitted with the present invention as cargo, a portion of the weight of the mountain would not be available for the metamorphic process while the present invention is in operation and rolling down the inclined plane. This due to the sequaciously storing and releasing of energy by the springs of the epicycloid rolling resistance abatement. During the operation process the mountain would have a decreased effective weight. The energy which would have provided for the rock metamorphic process, that is to say rock transmutation, during operation of the present invention, that is to say the effective weight, would not be available for the metamorphic process, in other words, the cause of the transmutation is absent. This process is similar to the above given basketball example. The effective weight of the basketball is only effective while the basketball rest upon the floor. Although the exact scientific principles are unclear, it is supposed this absent energy is the energy attributed for the increase of kinetic energy realized. Adherence to the energy conservation law is thereby accomplished in that the earth's internal energy is decreased by a corresponding increase of kinetic energy.

### BRIEF SUMMARY OF THE INVENTION

The present invention while operation under the influence of gravity provides a method by a unique combination of the elements described above for the acquisition of an increase of kinetic energy hitherto unknown. Subsequently, the increase of kinetic energy shall be converted to electrical energy or other form of energy. The energy yielded may also be stored for a later use and more timely use.

### DETAILED DESCRIPTION OF THE METHOD OF THE INVENTION

A method for creating kinetic energy using at least one wheel fitted with an epicycloid rolling resistance abatement means comprising the steps of situating the wheel fitted with an epicycloid rolling resistance abatement means upon an inclined plane and allowing said epicycloid rolling resistance abatement to roll down the inclined plane under the influence of gravity. Whereof subsequently realizing an increase of kinetic energy beyond the kinetic energy which would be realized by using a wheel and axle system without being fitted with said epicycloid rolling resistance abatement means. The portion of kinetic energy increase due to the present invention may subsequently be converted to electrical energy by means of the art of Wiggins, Hayes, and Ferrell or others. The portion of kinetic energy increase due to the present invention may subsequently be converted to electrical energy by means of momentum converters. Said converters may or not be mounted on the vehicle or on the vehicle wheels. Operation and method may use a multiplicity of predetermined and propositioned inclined planes. Inclined planes may or may not be inclined, that is to say a level plane may also be used. The plane may not be a plane at all but may be a curved surface. Operation and method may use a multiplicity of predetermined and propositioned epicycloid rolling resistance abatement. Operation and method may use a multiplicity of predetermined and propositioned vehicle wheels. Operation and method may use a multiplicity of predetermined and propositioned vehicles. Operation and method may use a multiplicity of predetermined and propositioned rumble strips. The operation and method may be place in a vacuum chamber wherein air resistance is mitigated.

The materials for the various components shall be consistent with material use for wheel, springs, roadways, rumble strips, vehicles etc. by those skilled the appropriate mechanical arts.

While the above description contains many specifics, the reader should not construe these as limitations on the scope of the invention, but merely as exemplifications of preferred embodiments thereof. Many other possible variations are within the scope of the present invention. Shape, dimensions, alternative materials, adjustments of mechanisms of the various embodiments are within the ability of anyibne skilled in the art of compression elements, springs, rumble strips, inclined planes, inclined planes with curved surfaces, roadway construction, epicycloid rolling resistance abatement, rotational transmission means, vehicles and vehicle wheels. Accordingly, the scope of the invention merits should be determined by the appended claims and their legal equivalents, and not by the examples which have been given.

I claim:

1. A method for creating kinetic energy using at least one wheel fitted with an epicycloid rolling resistance abatement means comprising the steps of:
placement of the wheel fitted with the epicycloid rolling resistance abatement means upon a surface;
allowing the wheel fitted with the epicycloid rolling resistance abatement means to roll down the surface;
whereby, realization of an increase of kinetic energy beyond the kinetic energy realized using a wheel not fitted with the epicycloid rolling resistance abatement means.

2. The method of claim 1 further including means for combination and cooperation with regenerative braking.

3. The method of claim 1 further including means providing in combination and cooperation with the converting the inertia of moving vehicles into power and energy.

4. The method of claim 1 further including means providing whereby slippage of the epicycloid rolling resistance abatement elements which coacting with roadway surfaces is precluded.

5. The method of claim 1 further including means providing in combination and cooperation with rumble strips.

6. The method of claim 1 further including means providing for combination and cooperation with a vacuum chamber.

7. The method of claim 1 further including means providing for combination and cooperation with inclined planes comprised of varying surface geometries.

8. The method of claim 1 further including means providing in combination and cooperation with a means to retract elements elongated beyond the periphery of the tire.

9. The method of claim 1 further including means providing in combination and cooperation with the transfer of deleterious heat from the operating elements.

10. The method of claim 1 further including means providing whereby in combination and cooperation with the configuration such that the tire is removed from the epicycloid rolling resistance abatement.

11. The method of claim 6 further including means providing transfer of deleterious heat.

12. All method of kinetic energy creation which does originates from the sun directly or indirectly in whole or in part.

13. The method of claim 12 further including means providing regenerative braking.

14. The method of claim 12 further including means providing for the converting the inertia of moving vehicles into power and energy.
